(19) United States
(12) Patent Application Publication
(10) Pub. No.: US 2015/0332797 A1
(43) Pub. Date: Nov. 19, 2015

(54) DEVICE FOR HEATING A PRESSURISER

(71) Applicant: SOCIETE TECHNIQUE POUR L'ENERGIE ATOMIQUE TECHNICATOME, VILLIERS LE BACLE (FR)

(72) Inventor: Jean-Pierre ROUX, AIX EN PROVENCE (FR)

(21) Appl. No.: 14/760,918

(22) PCT Filed: Jan. 15, 2014
(86) PCT No.: PCT/EP2014/050656

§ 371 Date: Jul. 14, 2015

(30) Foreign Application Priority Data
Jan. 15, 2013 (FR) 1350337

(51) Int. Cl. G21D 3/08; H05B 6/36; G21C 1/09; H05B 6/10

(52) U.S. Cl. CPC G21D 3/08; H05B 6/10; H05B 6/36; G21C 1/09

(57) ABSTRACT

An induction heating device for a pressuriser of a pressurized water nuclear reactor, which pressuriser includes an enclosure having an inner wall made of magnetic material, the induction heating device including a heating module having a winding mounting, and a winding of conductive wire wound around the winding mounting, the winding generating a magnetic field when an alternating electric current passes therethrough; and a module mounting that engages with an attachment device configured to removably attach the heating module to the module mounting, the module mounting being configured to position the heating module outside of the inner wall of the enclosure of the pressuriser in a position that makes it possible to heat the inner wall of the pressuriser by magnetic induction when an electric current passes through the winding of the heating module.

### TECHNICAL FIELD OF THE INVENTION

The invention relates to a heating device for a pressuriser of a pressurised water nuclear power plant and also a pressuriser of a pressurised water nuclear power plant including such a device.

### STATE OF PRIOR ART

Pressurised water nuclear reactors include a primary circuit wherein cooling water, called primary water, of the reactor is maintained at a high pressure, in the order of 155 bars, by means of a pressuriser.

The pressuriser enables the pressure in the primary circuit to be maintained within certain determined limits, either by spraying when the pressure tends to exceed the permissible upper limit, or by electrically heating the primary water when the pressure tends to decrease below the permissible lower value.

The pressuriser is formed by an enclosure having a lower part partially filled with primary water and an upper part filled with water vapour, at a pressure substantially equal to the pressure of water circulating in the primary circuit.

In order to increase the operating pressure of the primary circuit of the power plant, it is known to heat the primary water contained in the lower part of the pressuriser so as to bring it to its boiling temperature. Evaporation of part of the primary water enables the pressure in the upper part to be increased, the water vapour present in the upper part of the pressuriser being in hydrostatic equilibrium with water circulating in the primary circuit. The increase in pressure in the upper part of the pressuriser causes an increase in the operating pressure of the primary circuit.

The primary water contained in the pressuriser is generally heated by resistors called anti-condensation heaters passing through the pressuriser enclosure so as to be in contact with the primary water contained in the pressuriser and supplied with an electric supply means positioned outside the pressuriser. Such a heating means raises reliability problems because of the corrosion of the part of the anti-condensation heaters permanently dipped in the primary water, implementation problems because of the production, in the pressuriser enclosure, of holes enabling the anti-condensation heaters to pass therethrough, maintenance problems because of the sealing problems caused by the holes for passing the anti-condensation heaters therethrough and the difficulty changing an anti-condensation heater in case of breakdown of the latter.

Other heating means for the water contained in the pressuriser are described in document JP2004-170312. In particular, document JP2004-170312 describes different heating devices using the induction principle to heat the primary water of the pressuriser, such as a coil positioned around the pressuriser heating the pressuriser enclosure, an induction heating device welded under the pressuriser or induction heating devices passing through the pressuriser enclosure. However, these heating means do not enable a maintenance to be easily made in case of breakdown. Indeed, none of these heating means is readily dismountable, which further complicates maintenance operations and increases the shutdown times of the pressurisers, and thus of the facility. Further, the induction heating devices passing through the pressuriser enclosure, as described in document JP2004-170312, can have sealing problems.

### DISCLOSURE OF THE INVENTION

In this context, the invention aims at overcoming all or part of the drawbacks of the state of the art which are identified above, and in particular at providing a reliable heating device for a pressuriser of a pressurised water nuclear power plant facilitating on-site maintenance operations.

For that purpose, one aspect of the invention relates to an induction heating device for a pressuriser of a pressurized water nuclear reactor, which pressuriser includes an enclosure having an inner wall made of magnetic material, wherein the device comprises at least one heating module having:
a winding mounting;
a winding of conductive wire wound around said mounting, said winding generating a magnetic field when an alternating electric current passes therethrough;

said device is characterised in that it comprises a module mounting that engages with attachment means for removably attaching said heating module to said module mounting, said module mounting being suitable for positioning said heating module outside of the inner wall of the enclosure of said pressuriser in a position that makes it possible to heat said inner wall (211) of the pressuriser (2) by magnetic induction when an electric current passes through said winding of said heating module

Thanks to the construction of the device, its maintainability is increased. Indeed, the induction heating module can be easily reached by an operator during a maintenance operation because of its positioning outside the pressuriser. Furthermore, the use of a specific module mounting and/or removable attachment means enables operations of mantling/dismantling of the heating device to be made simply and quickly, without deteriorating neither the heating device nor the module mounting. The attachment means enabling a removable bond to be made between the module mounting and the heating module are for example screwing means. Of course, making a bond by means of a weld is not a removable bond and does not enable the heating module to be removably attached.

Advantageously, the mounting of the heating module is permanently (i.e. non-removably) attached to the outer wall of the pressuriser enclosure, and the heating module is removably (i.e. in a dismantlable way) attached to the module mounting and in proximity to the outer wall of the enclosure. Thus, the heating module can be easily dismantled for maintenance and moved if need be.

Such a heating device thus does not question the reliability of the pressuriser. Indeed, thanks to the device according to the invention, it is not necessary to provide through holes in the pressuriser enclosure to heat the primary water, which enables any risk of primary water leak to be dispensed with. Such an arrangement also enables the installation and the maintenance of the heating devices but also the manufacture of the pressuriser to be simplified.

The device according to the invention thus provides for a reliable heating enabling the water contained in the pressuriser to be heated by heating the inner wall made of magnetic material, of the steel type, by magnetic induction and heat transfer of the wall to the primary water contained in the pressuriser enclosure.

Heating the water contained in the pressuriser can be made by a plurality of heating modules, all positioned in proximity to the pressuriser enclosure. The number of heating modules to be provided at the wall of the pressuriser and their distribution depend on several parameters, among which the pressuriser dimensions, the demanded reaction time at the start of heating, the desired accuracy, etc.

Besides the main characteristics just mentioned in the preceding paragraph, the device according to the invention can have one or more complementary characteristics from the following ones, considered individually or according to technically possible combinations:
the device includes at least one conductive fin able to be secured to said conductive inner wall, said fin heating up by heat conduction with the wall and/or by magnetic induction under the action of the magnetic field generated by the winding;
the device includes an alternating current generator connected to said winding and a means for controlling said current generator;
the module mounting is formed by an annular strapping having at least one attachment plate for securing the winding mounting via said attachment means removably attaching said heating module, said annular strapping having a diameter suitable for being positioned around the enclosure of said pressuriser;
said module mounting is able to be secured to the outer wall of the enclosure of the pressuriser;
said module mounting is able to be removably mounted to the outer wall of the enclosure of the pressuriser;
the device includes a plurality of heating modules distributed on a zone to be heated.

The invention also relates to a pressuriser of a pressurised water nuclear reactor characterised in that it includes an enclosure having an inner wall made of magnetic material; an induction heating device according to the invention, positioned around the inner wall of said pressuriser, said heating device heating said conductive inner wall by magnetic induction.

Besides the main characteristics just mentioned in the preceding paragraph, the pressuriser according to the invention can have one or more complementary characteristics among the following ones, considered individually or according to technical possible combinations:
the enclosure includes an outer wall having a heat insulating neutral to magnetic induction; the presence of a heat insulating coating improves the heating efficiency of the water contained in the pressuriser by the heating device;
said heating device is positioned at the side part of said enclosure; the attachment of the heating module at the side wall of the pressuriser allows a greater heating area and enables an easier access for maintenance unlike a positioning under the pressuriser.

### BRIEF DESCRIPTION OF THE FIGURES

Further characteristics and advantages of the invention will appear upon reading the description that follows, with reference to the appended figures, which illustrate:

FIG. 1A, a front cross-section view and FIG. 1B a top cross-section view of a pressuriser and an induction heating device according to a first embodiment of the invention;

FIG. 2A, a top cross-section view and FIG. 2B, a side view of a pressuriser and an induction heating device according to a second embodiment of the invention.

For the sake of clarity, identical or similar elements are referenced by identical reference signs throughout the figures.

### DETAILED DESCRIPTION OF ONE EMBODIMENT

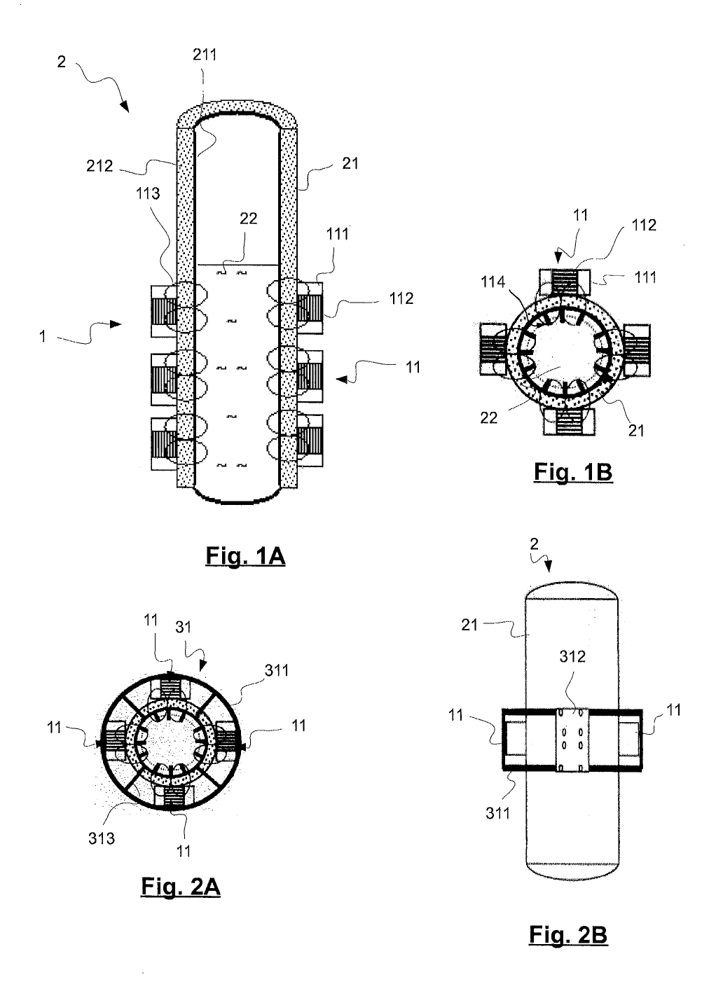

FIGS. 1A and 1B schematically illustrate a first exemplary embodiment of an induction heating device according to the invention positioned on a pressuriser 2 of a pressurised water nuclear power plant. FIG. 1A more precisely illustrates a cross-section view along a longitudinal plane of the pressuriser and FIG. 1B illustrates a cross-section view along a transverse plane of the pressuriser.

The pressuriser is formed by an enclosure 21 enclosing in its lower part primary water 22 of the primary circuit of the power plant. The enclosure 21 is formed by:
an inner wall 211 made of magnetic material, such as for example steel, which is directly in contact with the primary water 22;
a heat insulating outer wall 212.

In the exemplary embodiment illustrated in FIGS. 1A and 1B, the heating device 1 includes by way of illustration twelve heating modules 11 positioned at the side part of the enclosure 21, six modules being represented in FIG. 1A and four being represented in FIG. 1B.

Each heating module 11 includes a winding mounting 111 around which a winding 112 of electrically conductive wire is wound. The winding 112 of each heating module 11 is connected to an alternating current generator (not represented). When an electric current generated by said current generator passes through the winding 112, the winding 112 generates a variable magnetic field, illustrated by field lines referenced 113, which generates induced currents in the electrically conductive inner wall 211 of the pressuriser 2. The induced current in the inner wall 211 of the pressuriser causes heating up of the wall by the joule effect, and consequently of the primary water 22 contained in the pressuriser 2 by heat transfer.

The device also includes a means for controlling the alternating current generator which enables the induction heating of water contained in the pressuriser to be controlled and which can be connected to pressure sensors provided in the primary circuit of the power plant to which the pressuriser is connected in use, for example.

Advantageously, the device 1 also includes conductive fins 114, visible in the cross-section plane of FIG. 1B, attached to the inner face of the inner wall 211 of the pressuriser 2, which under the effect of the heat conduction and the induced current heat up and ensure homogenisation of the temperature of the water 22 of the pressuriser 2. A conductive fin also called heat exchange fin, optimises the heat energy transfer to the pressuriser water and improves the efficiency of the device by homogenising heating of the primary water 22 contained in the pressuriser 2. One or more fins 144 can be provided on the inner face of the inner wall 211 of the pressuriser so as to homogenise heat exchange inside the pressuriser 2.

The heating modules 11 are removably attached (i.e. dismantlable), via removable attachment means, to a module mounting (not visible in FIG. 1A) which is secured to the enclosure 21 of the pressuriser 2. The removable attachment means are for example screwing means which enable mantling/dismantling operations to be quickly and easily made without deteriorating assembled parts. Such a device thus enables a quick easy mantling/dismantling of the heating modules 11 in place to be ensured.

The heat insulating outer wall 212, and in particular its structure, is made of materials neutral to the magnetic induction (for example of aluminium for the structure). Advantageously, the heating device is provided outside the heat insulating wall 212 of the enclosure 21. However, according to one alternative embodiment, the induction heating device can also be provided in the structure of the heat insulating outer wall, the latter being then made up of plates associated with each heating module in order to facilitate mantling/dismantling operations thereof.

FIGS. 2A and 2B illustrate an exemplary embodiment of a module mounting of the induction heating device according to the invention. FIG. 2A more precisely illustrates a cross-section view along a transverse plane of the pressuriser and FIG. 2B illustrates a side view of the pressuriser.

In this exemplary embodiment, the mounting 31 of the heating modules 11 is formed by an annular strapping 311 having at its periphery at least one attachment plate 312 (visible in FIG. 2B) forming a planar support for enabling a heating module 11 to be removably attached.

Advantageously, the annular strapping 311 has a diameter higher than the diameter of the enclosure 21 so as to be capable of positioning the heating modules between the annular strapping 311 and the enclosure 21. The annular strapping 311 is permanently secured to the enclosure 21 of the pressuriser 2 via attachment means 313 having heat insulation properties, so as to avoid heat exchanges between the enclosure 21 of the pressuriser 2 and the annular strapping 311. The heating module 11 is mounted to the attachment plate 312 by removable attachment means, such as screws.

In this embodiment illustrated in FIGS. 2A and 2B, the induction heating device includes by way of example at a same height, four heating modules 11 distributed at the circumference of the enclosure 21 of the pressuriser 2. The annular strapping 311 secured to the enclosure 21 thus enables the heating modules to be positioned in proximity to the enclosure 21. The increase in the number of annular strappings around the enclosure 21 of the pressuriser 2, at different heights of the pressuriser 2, enables the number of heating modules 11 that can be provided along the wall of the pressuriser to be increased and thus the number of heating modules to be modulated, depending on the operator's needs.

The heating device can be easily automated. Indeed, the alternating current generator can be connected to a controlling means so as to manage the operating pressure of the primary circuit of the power plant, as is currently the case with the device for controlling the anti-condensation heaters.

The invention is not restricted to the embodiments previously described with reference to the figures and alternatives could be worth considering without departing from the scope of the invention.

According to another embodiment of the invention not illustrated, the module mountings can also be removably mounted to the pressuriser enclosure.

1. An induction heating device for a pressuriser of a pressurized water nuclear reactor, which pressuriser includes an enclosure having an inner wall made of magnetic material, the induction heating device comprising:
at least one heating module having
a winding mounting, and
a winding of conductive wire wound around said winding mounting, said winding generating a magnetic field when an alternating electric current passes therethrough; and
a module mounting (31) that engages with an attachment device configured to removably attach said heating module to said module mounting, said module mounting being configured to position said heating module outside of the inner wall of the enclosure of said pressuriser in a position that makes it possible to heat said inner wall of the pressuriser by magnetic induction when an electric current passes through said winding of said heating module.

2. The induction heating device of a pressuriser according to claim 1, further comprising at least one conductive fin configured to be secured to said inner wall, said conductive fin heating up by heat conduction with the wall and/or by magnetic induction under the action of the magnetic field generated by the winding.

3. The induction heating device of a pressuriser according to claim 1, further comprising an alternating current generator connected to said winding and a a controller configured to control said current generator.

4. The induction heating device of a pressuriser according to claim 1, wherein the module mounting is formed by an annular strapping having at least one attachment plate for securing the winding mounting via said attachment device removably attaching said heating module, said annular strapping having a diameter suitable for being positioned around the enclosure of said pressuriser.

5. The induction heating device of a pressuriser according to claim 1, wherein the module mounting is configured to be secured to an outer wall of the enclosure of the pressuriser.

6. The induction heating device of a pressuriser according to claim 1, wherein said module mounting is configured to be removably mounted to an outer wall of the enclosure of the pressuriser.

7. The induction heating device of a pressuriser according to claim 1, comprising a plurality of heating modules.

8. A pressuriser of a pressurised water nuclear reactor, comprising:
an enclosure having an inner wall made of magnetic material;
an induction heating device according to claim 1, positioned around the inner wall of said pressuriser, said induction heating device configured to heat said inner wall by magnetic induction.

9. The pressuriser of a pressurised water nuclear reactor according to claim 8, wherein the enclosure includes a heat insulating outer wall neutral to magnetic induction.

10. The pressuriser of a pressurised water nuclear reactor according to claim 9, wherein the induction heating device is positioned outside the heat insulating outer wall and/or in a structure of the heat insulating outer wall.

11. The pressuriser of a pressurised water nuclear reactor according to claim 8, wherein the heating device is positioned at a side part of said enclosure.
